(19) United States
(12) Patent Application Publication
(10) Pub. No.: US 2022/0355638 A1
(43) Pub. Date: Nov. 10, 2022

(54) ELECTRONICALLY CONTROLLED ADJUSTMENT SYSTEM FOR SWAY BARS

(71) Applicant: DANIEL J. WORLEY, LAKE ELSINORE, CA (US)

(72) Inventor: DANIEL J. WORLEY, LAKE ELSINORE, CA (US)

(73) Assignee: SUSPENSION DIRECT INC., LAKE ELSINORE, CA (US)

(21) Appl. No.: 17/307,460

(22) Filed: May 4, 2021

(51) Int. Cl. B60G 21/055; B60G 17/015

(52) U.S. Cl. CPC B60G 21/0558; B60G 17/0152; B60G 2202/135; B60G 2500/22; B60G 2600/202

(57) ABSTRACT

This invention pertains to sway bar systems, and a method of controlling their operation. Specifically, the present invention relates to provide a way of adjusting the response characteristics of a sway bar system by changing the structure of the typical sway bar links and regulating the modified structure by utilizing a hydraulic control unit. Said hydraulic control unit independently modifies the fluid path within each said sway bar links by use of one electronically controlled bi-directional valve allowing for closed or opened flow operation, determined by an electronic input being received.

This application claims the benefit of U.S. Provisional Patent Application Ser. No. 63/033,603, filed Jun. 2, 2020. The entire contents of Application Ser. No. 63/033,603 are hereby incorporated by reference herein.

### FIELD OF THE INVENTION

This invention pertains to sway bar systems, and a method of controlling their operation. Specifically, this invention relates to use of hydraulic cylinders allowing control the displacement of a sway bar on a vehicle, and to use of one hydraulic control unit to regulate flow of fluid within said hydraulic cylinders.

### BACKGROUND OF THE INVENTION

Sway bar, anti-sway bar, roll bar or anti-roll bar systems for vehicles typically function by forcibly maintaining both right and left sides of said vehicle leveled. In detail, a sway bar is coupled to a vehicle frame, each right and left end of said sway bar are respectively connected to vehicle's right and left wheel axle thanks to sway bar links. Said sway bar acts like a torsion spring helping vehicle's suspension to maintain vehicle leveled.

Heretofore, the general approach for adjusting the response characteristics of this sway bar system has been to modify the length of said sway bar links. More specifically, this has been accomplished by replacing said sway bar links by adjustable hydraulic dampers, controlled manually or electronically.

Past manually or electronically controlled sway bar damper links utilize a manual or electronic control device, such as valves piloted by solenoids, located on each said sway bar damper links. By controlling said valves, a fluid path is opened allowing fluid to flow between a damper link cylinder and its own fluid reserve, resulting in a change of dampening characteristics of said sway bar links, and so of the entire vehicle's sway bar system.

In more common sway bar systems, response characteristic adjustment works in a way that sway bar links are disconnected from vehicle's wheel axle sides, allowing right and left vehicle's sides to travel independently and without the resistance of the vehicle sway bar torsion spring characteristic.

Examples of such electronically controlled sway bar damper links are described and shown in US Patent US 2019/0100071 A1, and depict a sway bar system composed of at least one electronically controlled damper links, each electronically controlled damper links comprising its own fluid reserve cylinder, and its own electronic valve.

In the event of using two damper links on each side of the vehicle and independently controlling each sway bar links through its own electronic control system, such design would significantly rise the production cost of said sway bar system, in addition of increasing the total amount of electric energy required to use said sway bar system.

Moreover, as fluid does not flow between first link coupled to first end of sway bar and second link coupled to second end of sway bar, such sway bar system would not be directly balanced by its own couplings, and would involve a constant electronic control in order to function properly, which again would increase the total amount of electric energy required to use said sway bar system.

In the event of using only one electronic controlled damper link on one side of the vehicle, such design would become efficient by using less electric energy to function, but again this sway bar system would not be balanced as only one side of the vehicle would be dampened and electronically controlled.

In any event, such sway bar system includes sway bar links comprising their own fluid reserve, which would significantly rise the production cost of said sway bar system, and create a difficulty in adapting such system to any vehicle, as freeing enough room to mount such design around a vehicle wheel area can be hard to achieve.

Finally, such design does not describe a way to hydraulically control its system while not electronically controlled. By doing so, said sway bar system constantly relies on electronic inputs in order to function properly, which would also increase the total amount of electric energy required to use said sway bar system, and more importantly, in the event of an electric failure, such sway bar system would not be usable anymore, and the safety of the vehicle and users would be compromised.

To achieve optimum electronic control of a vehicle's sway bar system response characteristic, it would be advantageous to develop innovative devices allowing efficient and compact valve control.

### SUMMARY OF THE INVENTION

The object of the present invention is to provide a way of adjusting the response characteristics of a sway bar system by changing the structure of the typical sway bar links and regulating the modified structure by utilizing a hydraulic control unit. Said hydraulic control unit independently modifies the fluid path within each said sway bar links by use of one electronically controlled bi-directional valve allowing for closed or opened flow operation, determined by an electronic input being received.

### BRIEF DESCRIPTION OF THE DRAWINGS

A clear understanding of the sway bar control system summarized above may be had by examining the figures below. The figures display and reference the assembly, which are not necessarily drawn to scale. Accordingly:

FIG. 1: Illustrates a pair of hydraulic cylinders (6A) and (6B) mounted to a vehicle sway bar (14) and to both opposite vehicle wheel sides. Said hydraulic cylinders (6A) and (6B) are connected to a hydraulic control unit (16) comprising a bi-directional control valve (10) in opened position (9B) or closed position (9A), and an accumulator (13). Said vehicle sway bar (14) is mounted to vehicle by mounting brackets (15A) and (15B).

FIG. 2: Illustrates how the fluid flows in the system depicted in FIG. 1, when bi-directional control valve (10) of the hydraulic control unit (16) is in opened position (9B), and pair of hydraulic cylinders (6A) and (6B) are fully collapsed.

FIG. 3: Illustrates how the fluid flows in the system depicted in FIG. 1, when bi-directional control valve (10) of the hydraulic control unit (16) is in closed position (9A), and pair of hydraulic cylinders (6A) and (6B) are fully extended.

FIG. 4: Illustrates how the fluid flows in the system depicted in FIG. 1, when bi-directional control valve (10) of the hydraulic control unit (16) is in opened position (9B), hydraulic cylinder (6A) is fully collapsed, and hydraulic cylinder (6B) is fully extended.

FIG. 5: Illustrates how the fluid flows in the system depicted in FIG. 1, when bi-directional control valve (10) of the hydraulic control unit (16) is in opened position (9B), hydraulic cylinder (6A) is fully extended, and hydraulic cylinder (6B) is fully collapsed.

FIG. 6: Illustrates a variation of FIG. 1, where hydraulic cylinders (6A) and (6B) are individually connected to respectively bi-directional control valve (10A) and bi-directional control valve (10B) of the hydraulic control unit (16).

FIG. 7: Illustrates a pair of hydraulic cylinders (6A) and (6B) mounted to a vehicle sway bar (14) and to both opposite vehicle wheel side. Said hydraulic cylinders (6A) and (6B) are respectively connected through independent hydraulic lines (7A) and (7B) to a hydraulic control unit (16) comprising a bi-directional control valve (10) in opened position (9D) or closed position (9C), and an accumulator (13). Said vehicle sway bar (14) is mounted to vehicle by mounting brackets (15A) and (15B).

FIG. 8: Illustrates how the fluid flows in the system depicted in FIG. 6, when bi-directional control valve (10) of the hydraulic control unit (16) is in opened position (9D), and pair of hydraulic cylinders (6A) and (6B) are fully collapsed.

FIG. 9: Illustrates how the fluid flows in the system depicted in FIG. 6, when bi-directional control valve (10) of the hydraulic control unit (16) is in closed position (9C), and pair of hydraulic cylinders (6A) and (6B) are fully extended.

FIG. 10: Illustrates how the fluid flows in the system depicted in FIG. 6, when bi-directional control valve (10) of the hydraulic control unit (16) is in opened position (9D), hydraulic cylinder (6A) is fully collapsed, and hydraulic cylinder (6B) is fully extended.

FIG. 11: Illustrates how the fluid flows in the system depicted in FIG. 6, when bi-directional control valve (10) of the hydraulic control unit (16) is in opened position (9D), hydraulic cylinder (6A) is fully extended, and hydraulic cylinder (6B) is fully collapsed.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. Furthermore, the term “sway bar” refers to an anti-sway bar, a roll-bar, an anti-roll bar, a stabilizer bar or any similar system, while “hydraulic cylinders” refers to any damper cylinder, such as a shock or similar devices. An “eyelet” refers to the mounting of the hydraulic cylinders shaft to a chassis mounting point, and a “separating device” refers to the component used to separate the gas from the fluid inside an accumulator, such as a piston, bladder or diaphragm.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that several techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

An electronically controlled adjustment system for sway bars and its use is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

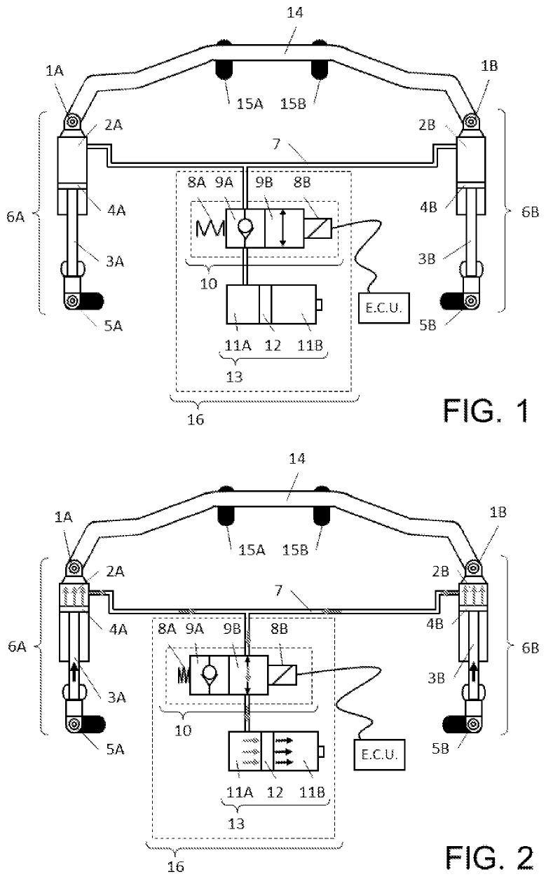

The present invention will now be described by referencing the appended figures representing preferred embodiments. FIG. 1 and FIG. 6 depict a vehicle sway bar system and its components, hydraulic cylinder main shafts (3A) and (3B) travels respectively through hydraulic cylinder main bodies (2A) and (2B). The hydraulic control unit (16) controls flow within hydraulic cylinders (6A) and (6B) thanks to bi-directional control valve unit (10). Said hydraulic cylinders are usually, but not exclusively, mounted on a vehicle with main body mounting eyelets (1A) and (1B) connected to each opposite sides of vehicle's sway bar (14), and main shaft mounting eyelets (5A) and (5B) connected to each opposite vehicle's wheel sides. When in operation, the controlling device (8B) receives an electronic input generated by an external electronic control unit. Said input is determined manually by vehicle's user through a human interface connected to said external electronic control unit, or automatically by an algorithm programmed into said external electronic control unit and calculated with transmitted inputs from vehicle sensors such as speed, roll angle and steering angle.

As seen on FIG. 2, when in operation, the controlling device (8B) receives an input and bi-directional control valve unit (10) of the hydraulic control unit (16) is in opened position (9B), which allow fluid to travel from said hydraulic cylinder main bodies (2A) and (2B) to the fluid reserve (11A) of accumulator (13). If any of hydraulic cylinders (6A) or (6B) collapses, meaning hydraulic cylinder main shafts (3A) or (3B) travel into hydraulic cylinder main bodies (2A) or (2B), fluid pressure generated by pistons (4A) or (4B) would be transferred in the fluid reserve (11A) of accumulator (13), through hydraulic line (7) and bi-directional control valve unit (10) of the hydraulic control unit (16) in opened position (9B). Ultimately, the pressure within the fluid reserve (11A) would compress gas in the gas reserve (11B) thanks to a separating device (12).

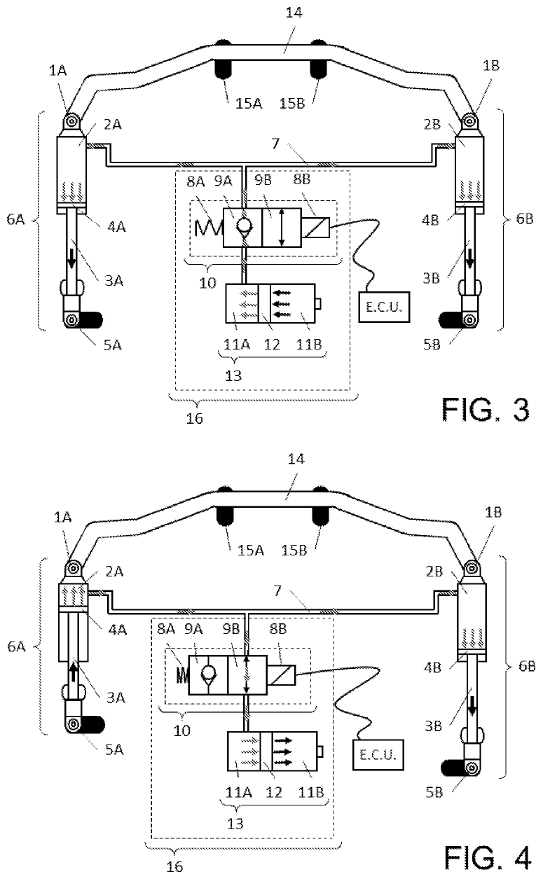

As seen on FIG. 3, when controlling device (8B) does not receive an input, controlling device (8A) acts like a compression spring and forces the bi-directional control valve unit (10) in closed position (9A) that comprises a check valve, which allow fluid to travel exclusively from the fluid reserve (11A) of the accumulator (13) to hydraulic cylinder main bodies (2A) and (2B). The gas in the gas reserve (11B) pressurize fluid in the fluid reserve (11A) thanks to a separating device (12). The fluid pressure generated in the fluid reserve (11A) is transferred to hydraulic cylinder main bodies (2A) and (2B), through hydraulic line (7) and bi-directional control valve unit (10) of the hydraulic control unit (16) in closed position (9A). Ultimately, the fluid pressure in hydraulic cylinder main bodies (2A) and (2B) fully extends hydraulic cylinders (6A) and (6B), as pressure applied on pistons (4A) and (4B) pushes hydraulic cylinder main shafts (3A) and (3B) out of hydraulic cylinder main bodies (2A) and (2B).

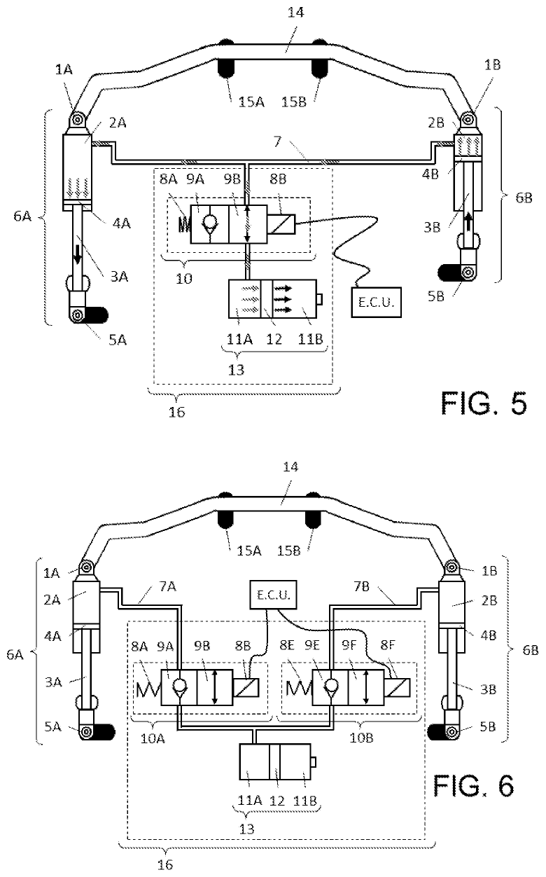

As seen on FIG. 4 and FIG. 5, when in operation, the controlling device (8B) receives an input and bi-directional control valve unit (10) of the hydraulic control unit (16) is in opened position (9B), which allow fluid to travel between said hydraulic cylinder main body (2A) and said hydraulic cylinder main body (2B). If any of hydraulic cylinders (6A) or (6B) collapses, meaning hydraulic cylinder main shafts (3A) or (3B) travel into hydraulic cylinder main bodies (2A) or (2B), fluid pressure generated by pistons (4A) or (4B) would be respectively transferred in hydraulic cylinder main bodies (2B) or (2A), through hydraulic line (7A) or (7B) and bi-directional control valve unit (10) in opened position (9B). Ultimately, the fluid pressure in hydraulic cylinder main bodies (2B) or (2A) respectively extends hydraulic cylinder (6B) or (6A), as pressure applied on pistons (4B) or (4A) pushes hydraulic cylinder main shafts (3B) or (3A) out of hydraulic cylinder main bodies (2B) or (2A). Any excess of fluid pressure would be then transferred in the fluid reserve (11A) of accumulator (13), through hydraulic line (7A) or (7B) and bi-directional control valve unit (10) of the hydraulic control unit (16) in opened position (9D). The excess of fluid pressure within the fluid reserve (11A) would compress gas in the gas reserve (11B) thanks to a separating device (12).

FIG. 6 depicts a variation of the vehicle sway bar system and its components depicted in FIG. 1, where hydraulic cylinder main shafts (3A) and (3B) travels respectively through hydraulic cylinder main bodies (2A) and (2B). The hydraulic control unit (16) controls flow within hydraulic cylinder (6A) thanks to bi-directional control valve unit (10A) and within hydraulic cylinder (6B) thanks to bi-directional control valve unit (10B). Said hydraulic cylinders are usually, but not exclusively, mounted on a vehicle with main body mounting eyelets (1A) and (1B) connected to each opposite sides of vehicle's sway bar (14), and main shaft mounting eyelets (5A) and (5B) connected to each opposite vehicle's wheel sides. When in operation, the controlling devices (8B) and (8F) receive electronic inputs generated by an external electronic control unit. Said inputs are determined manually by vehicle's user through a human interface connected to said external electronic control unit, or automatically by an algorithm programmed into said external electronic control unit and calculated with transmitted inputs from vehicle sensors such as speed, roll angle and steering angle. When controlling devices (8B) and (8F) do not receive inputs, controlling devices (8A) and (8E) act like compression springs and force the bi-directional control valve units (10A) and (10B) in closed positions (9A) and (9E).

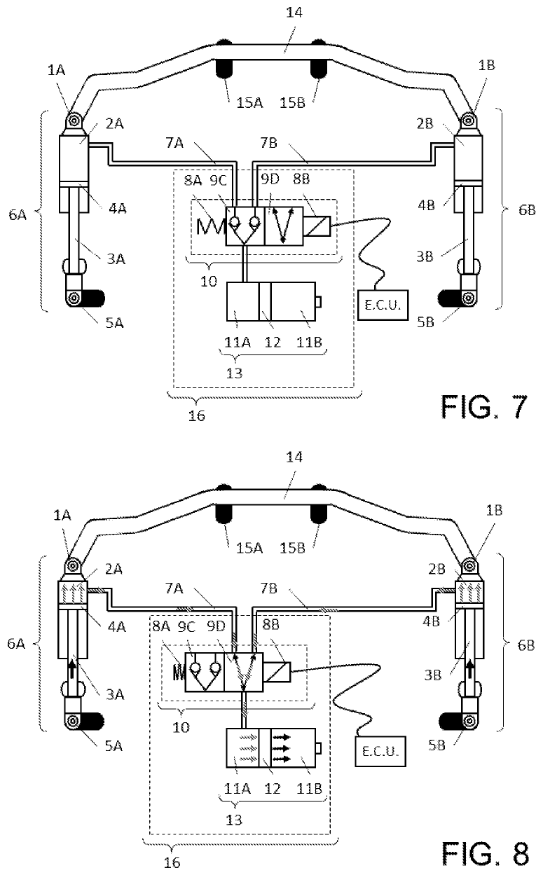

As seen on FIG. 7, when in operation, the controlling device (8B) receives an input and bi-directional control valve unit (10) of the hydraulic control unit (16) is in opened position (9D), which allow fluid to travel from said hydraulic cylinder main bodies (2A) and (2B) to the fluid reserve (11A) of accumulator (13). If any of hydraulic cylinders (6A) or (6B) collapses, meaning hydraulic cylinder main shafts (3A) or (3B) travel into hydraulic cylinder main bodies (2A) or (2B), fluid pressure generated by pistons (4A) or (4B) would be transferred in the fluid reserve (11A) of accumulator (13), through hydraulic line (7A) or (7B) and bi-directional control valve unit (10) of the hydraulic control unit (16) in opened position (9D). Ultimately, the pressure within the fluid reserve (11A) would compress gas in the gas reserve (11B) thanks to a separating device (12).

As seen on FIG. 8, when controlling device (8B) does not receive an input, controlling device (8A) acts like a compression spring and forces the bi-directional control valve unit (10) in closed position (9C) comprising one check valve per each hydraulic lines (7A) and (7B), which allow fluid to exclusively travel from the fluid reserve (11A) of accumulator (13) to independently hydraulic cylinder main body (2A) and hydraulic cylinder main body (2B). The gas in the gas reserve (11B) pressurize fluid in the fluid reserve (11A) thanks to a separating device (12). The fluid pressure generated in the fluid reserve (11A) is transferred to hydraulic cylinder main bodies (2A) and (2B), respectively through hydraulic line (7A) and (7B) and bi-directional control valve unit (10) in closed position (9C). Ultimately, the fluid pressure in hydraulic cylinder main bodies (2A) and (2B) fully extends hydraulic cylinders (6A) and (6B), as pressure applied on pistons (4A) and (4B) pushes hydraulic cylinder main shafts (3A) and (3B) out of hydraulic cylinder main bodies (2A) and (2B).

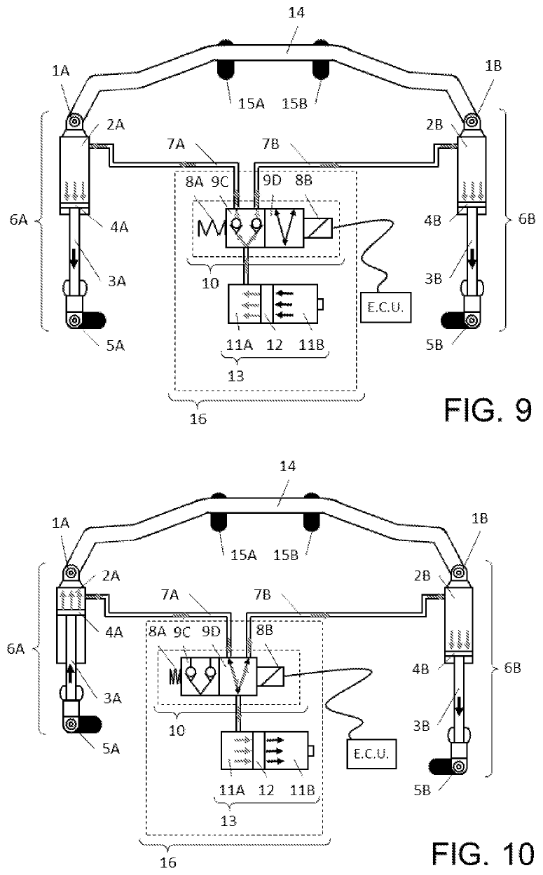

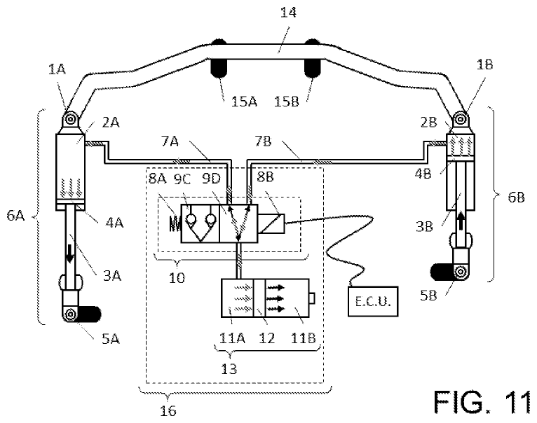

As seen on FIG. 9 and FIG. 10, when in operation, the controlling device (8B) receives an input and bi-directional control valve unit (10) of the hydraulic control unit (16) is in opened position (9D), which allow fluid to travel between said hydraulic cylinder main body (2A) and said hydraulic cylinder main body (2B). If any of hydraulic cylinders (6A) or (6B) collapses, meaning hydraulic cylinder main shafts (3A) or (3B) travel into hydraulic cylinder main bodies (2A) or (2B), fluid pressure generated by pistons (4A) or (4B) would be respectively transferred in hydraulic cylinder main bodies (2B) or (2A), through hydraulic line (7A) or (7B) and bi-directional control valve unit (10) of the hydraulic control unit (16) in opened position (9D). Ultimately, the fluid pressure in hydraulic cylinder main bodies (2B) or (2A) respectively extends hydraulic cylinder (6B) or (6A), as pressure applied on pistons (4B) or (4A) pushes hydraulic cylinder main shafts (3B) or (3A) out of hydraulic cylinder main bodies (2B) or (2A). Any excess of fluid pressure would be then transferred in the fluid reserve (11A) of accumulator (13), through hydraulic line (7A) or (7B) and bi-directional control valve unit (10) of the hydraulic control unit (16) in opened position (9D). The excess of fluid pressure within the fluid reserve (11A) would compress gas in the gas reserve (11B) thanks to a separating device (12).

The operation of controlling device (8B) increases or decreases the response characteristics of the vehicle's sway bar system.

This electronically controlled adjustment system for sway bars is designed to work with any style of sway bar systems. This design offers an efficient and compact way of electronically controlling the response characteristics of a vehicle's sway bar, as it is all contained within one central control unit that dispatches fluid control in all sway bar links, rather than controlling each sway bar link with its individual control unit and its own fluid reserve.

It also provides efficient performance, as sway bar links mounted on both opposite sides of the vehicle can be controlled proportionally from each other and offer great balance control of the vehicle in any driving condition.

Electric energy savings is another great advantage of the present electronically controlled adjustment system for sway bars, as only one electronic control device is required for this system to function properly, and as specific hydraulic connections allow this system to function safely without using electric energy when not in operation.

Finally, the production cost of such system is lowered as less parts are required for the final assembly, which also allows an easier adaptation on any vehicle as less room around vehicle wheel axles is required for proper mounting.

1. An electronically controlled adjustment system for sway bars, comprising of:
A. At least one hydraulic cylinder, composed of:
A main body comprising a mounting eyelet,
A main shaft traveling through said main body, comprising of:
a piston,
a mounting eyelet,
B. A hydraulic control unit composed of:
At least one bi-directional control valve, including:
an open flow body,
a check valve body,
and piloted by two controlling devices:
a spring,
a solenoid,
At least one accumulator composed of:
a gas reserve,
a fluid reserve,
a separating device used to separate the gas from the fluid inside the accumulator,
C. Hydraulic lines connecting said hydraulic cylinder with said hydraulic control unit,
Where said hydraulic cylinder links one vehicle's sway bar end to said vehicle axle end, and where hydraulic control unit regulates fluid flow within said accumulator and said hydraulic cylinder in order to change the rigid characteristic of a vehicle's sway bar. Said hydraulic control unit is piloted by a controlling device receiving electronic inputs generated by an external electronic control unit.

2. An electronically controlled adjustment system for sway bar of claim 1 wherein:
Said check valve body comprises two outputs, connected to two independent hydraulic lines and two check valves, and one input connected to said accumulator.

3. An electronically controlled adjustment system for sway bar of claim 1 or 2 wherein:
Said electronic inputs are determined manually by vehicle's user through a human interface connected to said external electronic control unit.

4. An electronically controlled adjustment system for sway bar of claim 1, 2, or 3 wherein:
Said electronic inputs are determined automatically by an algorithm programmed into said external electronic control unit and calculated with transmitted inputs from vehicle sensors.

5. A vehicle composed of an electronically controlled adjustment system for sway bar as disclosed in claim 1, 2, 3 or 4.
